(19) United States
(12) Patent Application Publication
(10) Pub. No.: US 2024/0089554 A1
(43) Pub. Date: Mar. 14, 2024

(54) METHODS AND SYSTEMS FOR MANAGING CAPTION INFORMATION

(71) Applicant: DISH Network L.L.C., Englewood, CO (US)

(72) Inventors: Caroline Condon, Denver, CO (US); Amber Bellerjeau, Littleton, CO (US); Luke E. VanDuyn, Conifer, CO (US)

(21) Appl. No.: 17/944,736

(22) Filed: Sep. 14, 2022

(51) Int. Cl. H04N 21/488; H04N 7/088; H04N 21/43; H04N 21/485

(52) U.S. Cl. CPC H04N 21/4884; H04N 7/0885; H04N 21/43074; H04N 21/4856

(57) ABSTRACT

A technique is directed to methods and systems for managing caption information. In some implementations, the method includes (1) receiving, at a server, user information describing a user's preference of caption information; (2) generating, at the server, one or more sets of caption information based on the user information; (3) transmitting the one or more sets of caption information to a first client device via a first route; and (4) transmitting video content associated with the one or more sets of caption information to a second client device via a second route different than the first route.

### BACKGROUND

Closed captioning (CC) is a process of displaying text on a television, video screen, or other visual display to provide additional or interpretive information. Conventional CC systems provide only a small number of language options for viewers to choose from. Conventional CC systems generate caption information locally (e.g., at the display end), and their CCs and video streaming can be asynchronous and thus problematic. The conventional CC systems also transmit their CCs and videos in the same means, which requires significant amount of transmission resources especially when multiple language options are provided. Therefore, it is advantageous to have an improved system and method to address the foregoing needs.

### BRIEF DESCRIPTION OF THE DRAWINGS

FIG. 1 is a schematic diagram illustrating a system for managing caption information in accordance with some implementations of the present disclosure.

FIG. 2 is a schematic diagram illustrating methods (e.g., server side) of managing and transmitting the caption information in accordance with some implementations of the present disclosure.

FIG. 3 is a block diagram illustrating an overview of devices on which some implementations can operate.

FIG. 4 is a block diagram illustrating an overview of an environment in which some implementations can operate.

FIG. 5 is a flow diagram illustrating methods (e.g., client side) in accordance with some implementations of the present disclosure.

FIG. 6 is a flow diagram illustrating methods in accordance with some implementations of the present disclosure.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for managing caption information (or any other suitable information that can be displayed with videos). The caption information can be in various languages. The present systems enable user's customization of caption information to be received, as well as associated methods managing and transmitting such caption information.

In some embodiments, for example, the present system can include a server, a client video receiving device, and a client caption information receiving device. The server is configured to manage the caption information in multiple languages, including translating the caption information from one language to another, storing associated files/data, as well as managing user profiles (e.g., user language preferences, user subscription plans, types or configurations of user devices, etc.).

The client video receiving device is configured to receiving video content (e.g., including images and audio content) from the server. In some embodiments, the client video receiving device can be a satellite receiving device that can communicate with the server via various wired and/or wireless communications (e.g., a 5G network).

The client caption information receiving device is configured to receive the caption information from the server. In some embodiments, the client caption information receiving device can receive the caption information via the Internet. In some embodiments, the client caption information receiving device is also configured to receive the video content from the client video receiving device, combine it with the received caption information (e.g., check/adjust synchronization), and then transmit the combined video and caption information to a user device (e.g., a television, a portable device, a smartphone, a pad, a projector, etc.) for display.

In some embodiments, the foregoing communications can be in a specific frequency band, such as a CBRS (Citizens Broadband Radio Service) band (e.g., 3550-3700 MHz), etc. In some embodiments, the foregoing communications can be made via multiple communication protocols such as WiFi, 5G, LTE, 3GPP, etc. In some embodiments, the communications can be performed via a dedicated communication channel.

One aspect of the present system is that it provides customized caption information service for a user. In some embodiments, for example, the present system can (1) receive user information describing a user's selection of caption information; (2) generating one or more sets of caption information based on the user's selection of caption information; (3) transmitting the one or more sets of caption information to a first client device (e.g., the client caption information receiving device discussed above); and (4) transmitting video content associated with the one or more sets of caption information to a second client device (e.g., the client video receiving device discussed above).

In some embodiments, the first client device can combine and/or integrate the received video content and the caption information (e.g., check synchronization), and then transmit the combined video and caption information to a display device for viewing. In some embodiments, the first client device and the second client device can be integrated as one device that can perform both functions as described above.

Another aspect of the present system is that the present system provides a method for verifying or adjusting synchronization of caption information and a corresponding video. For example, assuming that there is a person talking in the video. The present system can identify images associated with mouth movements of the person, analyze the identified images (e.g., comparing to a trained artificial intelligence (AI) model), and adjust the timing of disapplying the caption information and the video such that they are synchronized. In some embodiments, the foregoing synchronization process can be performed by a server. In some embodiments, the foregoing synchronization process can be performed by a client device (e.g., the first client device, the client caption information receiving device, etc.).

Technical advantages of the present disclosure includes that it provides a customized caption information for users. For example, convention systems only provide a few language options (e.g., English, Spanish, Mandarin, etc.). For viewers who want to view captions with non-offered languages (e.g., Albanian, Hindi, Arabic, etc.), the present disclose enables the viewers to view captions in non-offered languages.

For example, assuming that a viewer wants to view an English video with an Arabic caption. In such case, the present system can translate the existing English caption to Arabic caption. As another example, if a viewer wants to view a Hindi video (assuming that only Hindi caption is available) in English, the present system can translate the existing Hindi caption to English caption.

In some embodiments, the present system can identify (i) the absence of a specific language of close-captioned data, or (ii) the absence of close-captioned data altogether. The system can further supplement a video presentation with an overlay (e.g., via a client device such as a gateway) offering of close-captioned data. In some embodiments, the system can provide an option to extract, process, convert, link, etc. for a real-time translation service (e.g., in the cloud).

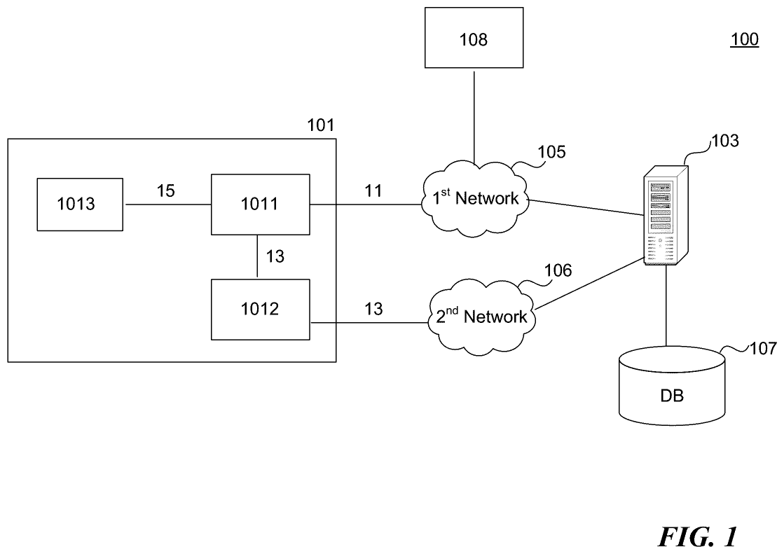

Several implementations are discussed below in more detail in reference to the figures. FIG. 1 is a schematic diagram illustrating a system 100 for managing caption information. The system 100 includes a client site in communication with a server 103 via a first network 105 and a second network 106. The client site 101 includes a first client device 1011, a second client device 1012, and a displaying device 1013. The system 100 can include a cloud-based application (or service) 108 configured to generate caption information in on or more target languages. In some embodiments, the cloud-based application 108 can be implemented by the server 103.

The first client device 1011 is configured to receive caption information 11 from the server 103 via the first network 105. In some embodiments, the first network 105 can be the Internet. The second client device 1012 is configured to receive video content 13 from the server 103 via the second network 106. In some embodiments, the second network 106 can be a 5G network or a satellite network. In some embodiments, the first network 105 and the second network 106 can be different communication channels/routes in the same network.

In some embodiments, the first client device 1011 is further configured to combine and/or integrate the received video content 13 and the caption information 11 so as to generate a combined video 15. The combined video 15 is then transmitted to the displaying device 1013 for viewing.

In some embodiments, the first client device 1011 can verify, adjust, and/or synchronize the caption information 11 and the video content 13. In some embodiments, the foregoing synchronization process can be performed based on a trained model. For example, the trained model can include multiple parameters with different weighting values, and each of the parameters contributes or relate to the foregoing synchronization process to a certain extent (e.g., indicated by the weighting values). The multiple parameters can include, for example, mouth/lip movements of a person talking in the video content 13, the shapes and/or sizes of the mouth/lip of the person, etc.

In some embodiments, the caption information 11 is a customized caption information (e.g., customized by the cloud-based application 108). For example, the customized caption information can be decided based on a user selection, a predicted user preference (e.g., according to prior viewing history), etc. In some embodiments, the first client device 1011 and the second client device 1012 can be integrated as one device that can perform both functions as described above.

The server 103 can further connect to a database 107. The database 107 is configured to store data and information such as caption information in multiple languages, data analyzed or trained by the server 103, user profile information (e.g., user language preferences, user subscription plans, types or configurations of user devices, etc.) and/or other suitable information.

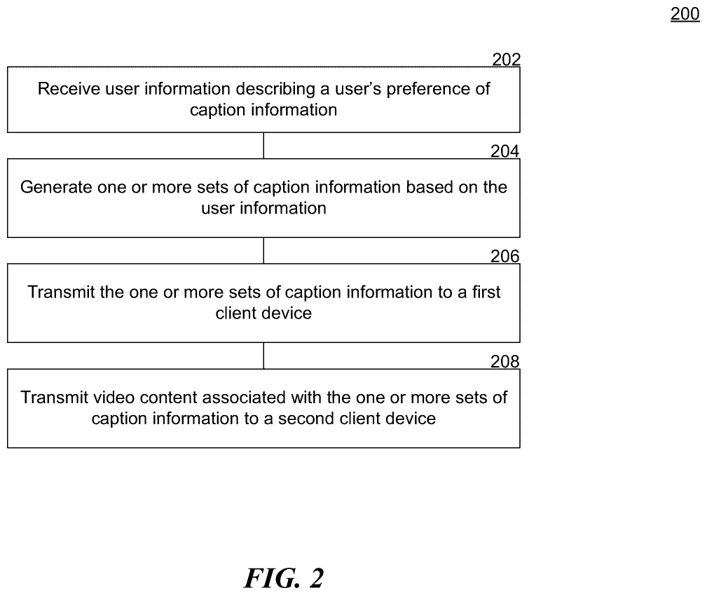

FIG. 2 is a schematic diagram illustrating a method 200 for managing and transmitting the caption information in accordance with some implementations of the present disclosure. The method 200 can be implemented by a server (e.g., the server 103). At block 202, the method 200 starts by receiving user information describing a user's preference of caption information. In some embodiments, the user information can include a user selection of caption languages (e.g., the server sends a request and then receives a response including the user selection). In some embodiments, the user information can be obtained based on the server's prediction based on user's subscription history, user profile, viewing history, etc.

At block 204, the server can generate one or more sets of caption information based on the user information. In some embodiments, the server identifies a target or selected language, and then generates the one or more sets of caption information (i.e., in the target or selected language) by translating from captions in existing languages.

At block 206, the method 200 continues by transmitting the one or more sets of caption information to a first client device (e.g., the client caption information receiving device discussed above) via a first route. In some embodiments, the first route can include communications via the Internet.

At block 208, the method 200 continues by transmitting video content associated with the one or more sets of caption information to a second client device (e.g., the client video receiving device discussed above) via a second route different from the first route. In some embodiments, the second route can be a satellite transmission.

Once the first client device can then combine and/or integrate the received video content and the one or more sets of caption information and generate a combined video 15 for viewing. The combined video 15 can then transmitted to a displaying device for viewing.

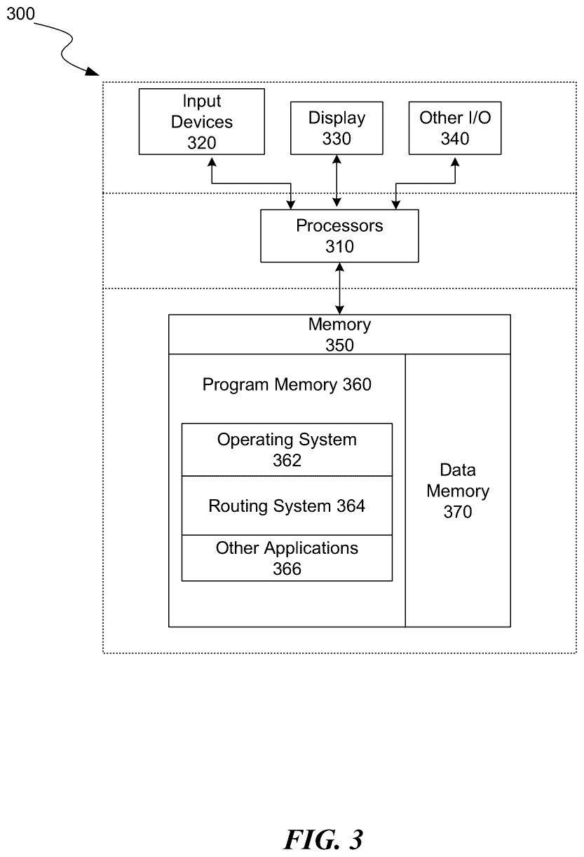

FIG. 3 is a block diagram illustrating an overview of devices (e.g., the server 103, the first client device 1011, the second client device 1012, and the displaying device 1013) on which some implementations can operate. Device 300 can include one or more input devices 320 that provide input to the processor(s) 310 (e.g., CPU(s), GPU(s), etc.), notifying it of actions. The actions can be mediated by a hardware controller that interprets the signals received from the input device and communicates the information to the processors 310 using a communication protocol. Input devices 320 include, for example, a mouse, a keyboard, a touchscreen, an infrared sensor, a touchpad, a wearable input device, a camera- or image-based input device, a microphone, or other user input devices.

Processors 310 can be a single processing unit or multiple processing units in a device or distributed across multiple devices. Processors 310 can be coupled to other hardware devices, for example, with the use of a bus, such as a PCI bus or SCSI bus. The processors 310 can communicate with a hardware controller for devices, such as for a display 330. Display 330 can be used to display text and graphics. In some implementations, the display 330 provides graphical and textual visual feedback to a user. In some implementations, the display 330 includes the input device as part of the display, such as when the input device is a touchscreen or is equipped with an eye direction monitoring system. In some implementations, the display is separate from the input device. Examples of display devices include an LCD display screen, an LED display screen, a projected, holographic, or augmented reality display (such as a heads-up display device or a head-mounted device), and so on. Other I/O devices 340 can also be coupled to the processor, such as a network card, video card, audio card, USB, firewire or other external device, camera, printer, speakers, CD-ROM drive, DVD drive, disk drive, or Blu-Ray device.

In some implementations, the device 300 also includes a communication device capable of communicating wirelessly or wire-based with a network node. The communication device can communicate with another device or a server through a network using, for example, TCP/IP protocols. The device 300 can utilize the communication device to distribute operations across multiple network devices.

The processors 310 can have access to a memory 350 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, routing system 364 (e.g., for implementing the routing plan discussed herein), and other application programs 366. The memory 350 can also include data memory 370, user interface data, event data, image data, biometric data, sensor data, device data, location data, network learning data, application data, alert data, structure data, camera data, retrieval data, management data, notification data, configuration data, settings, user options or preferences, etc., which can be provided to the program memory 360 or any element of the device 300.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

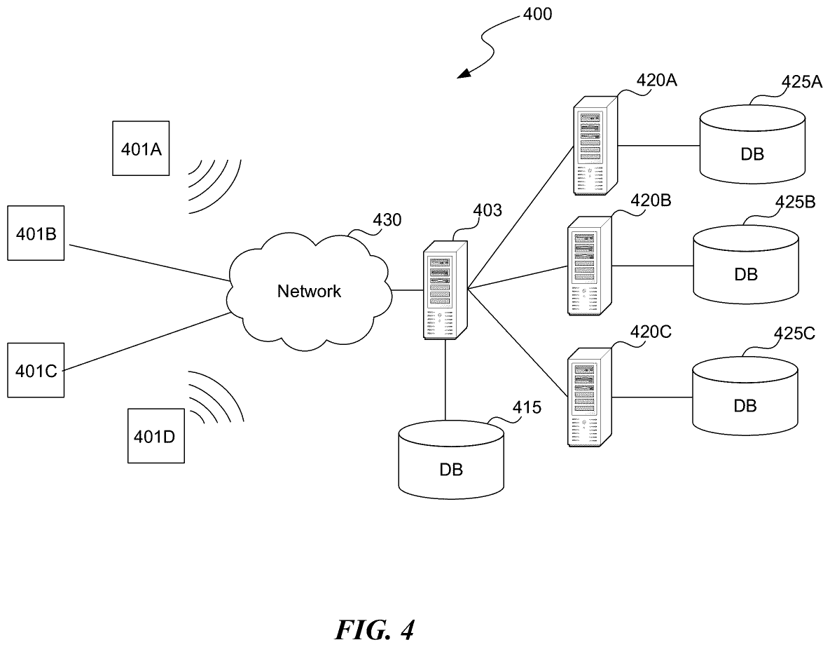

FIG. 4 is a block diagram illustrating an overview of an environment 400 in which some implementations can operate. The environment 400 can include one or more client computing devices 401A-D, examples of which can include the first client device 1011, the second client device 1012, and the displaying device 1013. The client computing devices 401 can operate in a networked environment using logical connections through network 430 to one or more remote computers, such as a server computing device 403.

In some implementations, the server computing device 403 can be an edge server which receives client requests and coordinates fulfillment of those requests through other servers, such as servers 420A-C. Server computing devices 403 and 420 can comprise computing systems, such as the device 300 discussed above. Though each server computing device 403 and 420 is displayed logically as a single server, server computing devices can each be a distributed computing environment encompassing multiple computing devices located at the same or at geographically disparate physical locations. In some implementations, each server 420 corresponds to a group of servers.

The client computing devices 401 and the server computing devices 403 and 420 can each act as a server or client to other server/client devices. Server 403 can connect to a database 415. Servers 420A-C can each connect to a corresponding database 425A-C. As discussed above, each server 420 can correspond to a group of servers, and each of these servers can share a database or can have their own databases.

The databases 415/425 can store information such as implement data, user interface data, event data, image data, detection data, biometric data, sensor data, device data, location data, network learning data, application data, alert data, structure data, camera data, retrieval data, management data, notification data, configuration data. Though databases 415/425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN), but can also be other wired or wireless networks. The network 430 may be the Internet or some other public or private network. The client computing devices 401 can be connected to the network 430 through a network interface, such as by wired or wireless communication. While the connections between server 403 and servers 420 are shown as separate connections, these connections can be any kind of local, wide area, wired, or wireless network, including network 430 or a separate public or private network.

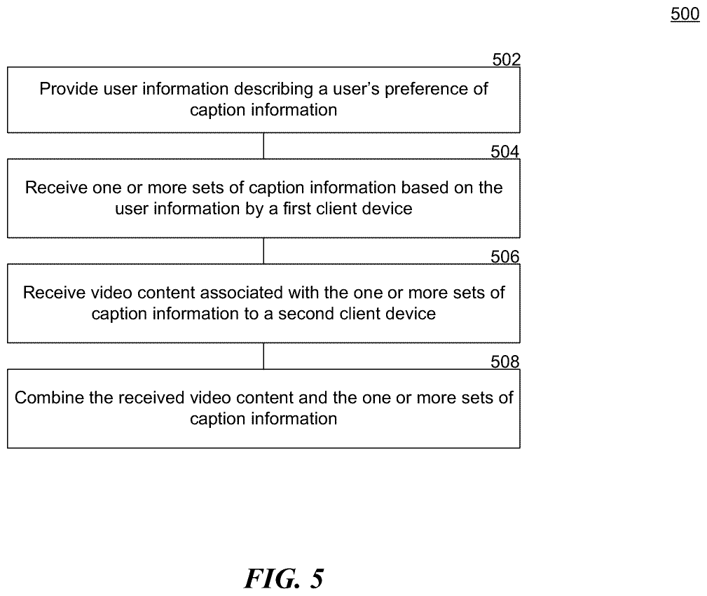

FIG. 5 is a flow diagram illustrating a method 500 used in some implementations for managing caption information. In some embodiments, the method 500 can be implemented by client devices (e.g., the first client device 1011, the second client device 1012, and the displaying device 1013) discussed herein.

At step 502, the method 500 start by providing user information describing a user's preference of caption information. In some embodiments, the user information can include a user selection of caption languages (e.g., the server sends a request and then receives a response including the user selection).

At block 504, the method 500 can continue by receiving one or more sets of caption information based on the user information by a first client device (e.g., the client caption information receiving device discussed above). In some embodiments, the one or more sets of caption information can be generated by translating from captions in existing languages. In some embodiments, the one or more sets of caption information can be received via a first route. In some embodiments, the first route can include communications via the Internet.

At block 506, the method 500 continues by receiving video content associated with the one or more sets of caption information to a second client device (e.g., the client video receiving device discussed above). In some embodiments, the video content can be received via a second route different from the first route. In some embodiments, the second route can be a satellite transmission.

At block 508, the method 500 continues by combining the received video content and the one or more sets of caption information so as to generate a combined video. In some embodiments, the combined video can be generated by the first client device. In some embodiments, the combined video can be generated by the second client device. In some embodiments, the method 500 further comprises transmitting the combined video to a displaying device for viewing.

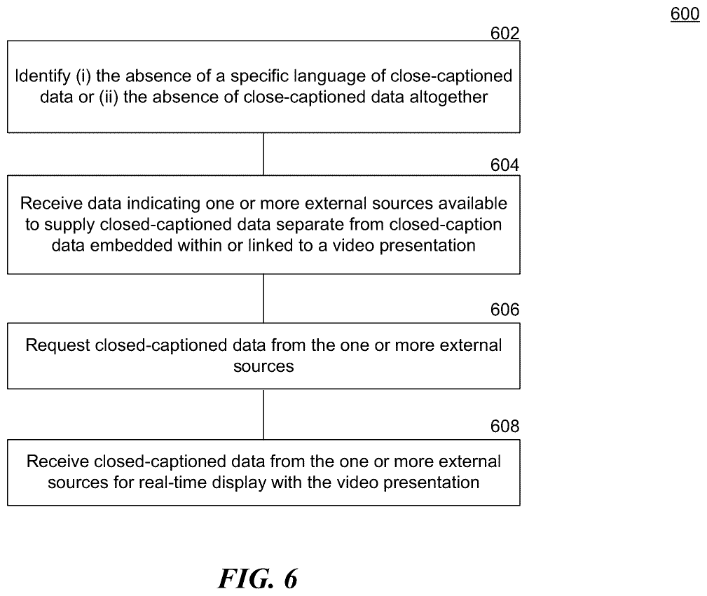

FIG. 6 is a schematic diagram illustrating a method 600 in accordance with some implementations of the present disclosure. The method 600 can be implemented by a server (e.g., the server 103). At block 602, the method 200 starts by identifying (i) the absence of a specific language of close-captioned data, or (ii) the absence of close-captioned data altogether.

Once the foregoing absence has been identified, the method 600 can continue, at block 604, by receiving data indicating one or more external sources available to supply closed-captioned data separate from closed-caption data embedded within or linked to a video presentation. In some embodiments, the video presentation can include an overlay (e.g., via a client device such as a gateway) offering of close-captioned data.

At block 606, the method 600 can request closed-captioned data from the one or more external sources. In some embodiments, the one or more external sources can provide a real-time translation service (e.g., in the cloud). At block 608, the method 600 can then receive closed-captioned data from the one or more external sources for real-time display with the video presentation.

Those skilled in the art will appreciate that the components illustrated in FIGS. 1-6 described above, and in each of the flow diagrams discussed below, may be altered in a variety of ways. For example, the order of the logic may be rearranged, sub-steps may be performed in parallel, illustrated logic may be omitted, other logic may be included, etc. In some implementations, one or more of the components described above can execute one or more of the processes described below.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1. A method, comprising:
receiving, at a server, user information describing a requested language to present caption information to a user;
determining an absence of closed captioned data, associated with video content, in the requested language of the user;
in response to determining the absence of the closed captioned data, requesting by the server from at least one external source, one or more sets of caption information in the requested language of the user;
receiving, from the at least one external source, the one or more sets of caption information in the requested language of the user, wherein the one or more sets of caption information is separate from closed-caption data embedded within or linked to the video content;
transmitting the one or more sets of caption information to a first client device via a first route; and
transmitting the video content associated with the one or more sets of caption information to a second client device via a second route different than the first route.

2. The method of claim 1, further comprising combining the video content and the one or more sets of caption information by the first client device.

3. The method of claim 1, further comprising combining the video content and the one or more sets of caption information by the second client device.

4. The method of claim 2, further comprising transmitting the combined video to a displaying device for viewing.

5. The method of claim 1, wherein the first route includes communications via an Internet device.

6. The method of claim 1, wherein the second route includes communications via a satellite.

7. The method of claim 1, wherein the one or more sets of caption information include a customized caption information based on the user information, and wherein the customized caption information is generated in response to an event that the server identifies an absence of closed captioned data in a specific language.

8. The method of claim 7, wherein the customized caption information is generated by translating from an existing caption in an existing language.

9. The method of claim 1, further comprising synchronizing the video content and the one or more sets of caption information at least based on a trained model including parameters associated with mouth movements of a speaker shown in the video content.

10. The method of claim 9, further comprising synchronizing the video content and the one or more sets of caption information by the first client device.

11-19. (canceled)

20. A computing system comprising:
at least one processor; and
at least one memory storing instructions that, when executed by the at least one processor, cause the computing system to perform a process comprising:
receiving, at a server, user information describing a requested language to present caption information to a user;
determining an absence of closed captioned data, associated with video content, in the requested language of the user;
in response to determining the absence of the closed captioned data, requesting by the server from at least one external source, one or more sets of caption information in the requested language of the user;
receiving, from the at least one external source, the one or more sets of caption information in the requested language of the user, wherein the one or more sets of caption information is separate from closed-caption data embedded within or linked to the video content;
transmitting the one or more sets of caption information to a first client device via a first route; and
transmitting the video content associated with the one or more sets of caption information to a second client device via a second route different than the first route.

21. A non-transitory computer-readable medium storing instructions that, when executed by a computing system, cause the computing system to perform operations comprising:
receiving, at a server, user information describing a requested language to present caption information to a user;
determining an absence of closed captioned data, associated with video content, in the requested language of the user;
in response to determining the absence of the closed captioned data, requesting by the server from at least one external source, one or more sets of caption information in the requested language of the user;
receiving, from the at least one external source, the one or more sets of caption information in the requested language of the user, wherein the one or more sets of caption information is separate from closed-caption data embedded within or linked to the video content;
transmitting the one or more sets of caption information to a first client device via a first route; and
transmitting the video content associated with the one or more sets of caption information to a second client device via a second route different than the first route.

22. The non-transitory computer-readable medium of claim 21, wherein the operations further comprise:
combining the video content and the one or more sets of caption information by the first client device.

23. The non-transitory computer-readable medium of claim 21, wherein the operations further comprise:
combining the video content and the one or more sets of caption information by the second client device.

24. The non-transitory computer-readable medium of claim 22, wherein the operations further comprise:
transmitting the combined video to a displaying device for viewing.

25. The non-transitory computer-readable medium of claim 21, wherein the first route includes communications via an Internet device.

26. The non-transitory computer-readable medium of claim 21, wherein the second route includes communications via a satellite.

27. The non-transitory computer-readable medium of claim 21, wherein the one or more sets of caption information include a customized caption information based on the user information, and wherein the customized caption information is generated in response to an event that the server identifies an absence of closed captioned data in a specific language.

28. The non-transitory computer-readable medium of claim 27, wherein the customized caption information is generated by translating from an existing caption in an existing language.

29. The non-transitory computer-readable medium of claim 21, wherein the operations further comprise:
synchronizing the video content and the one or more sets of caption information at least based on a trained model including parameters associated with mouth movements of a speaker shown in the video content; and
synchronizing the video content and the one or more sets of caption information by the first client device.
